(19) United States
(12) Patent Application Publication
(10) Pub. No.: US 2012/0309602 A1
(43) Pub. Date: Dec. 6, 2012

(54) METHOD FOR PRODUCING ROLLER FOR OFFICE AUTOMATION EQUIPMENT AND ROLLER FOR OFFICE AUTOMATION EQUIPMENT

(75) Inventors: Shingo Nakajima, Osaka-shi (JP); Jun Sugawara, Osaka-shi (JP); Yoshimasa Suzuki, Sennan-gun (JP); Yusuke Uchiba, Sennan-gun (JP); Masatoshi Ishikawa, Sennan-gun (JP)

(73) Assignees: SUMITOMO ELECTRIC FINE POLYMER, INC., Sennan-gun (JP); SUMITOMO ELECTRIC INDUSTRIES, LTD., Osaka-shi (JP)

(21) Appl. No.: 13/579,404

(22) PCT Filed: Jan. 12, 2011
(86) PCT No.: PCT/JP2011/050301

§ 371 Date: Aug. 16, 2012

(30) Foreign Application Priority Data
Feb. 26, 2010 (JP) 2010-041143

(51) Int. Cl. F16C 13/00; B05D 3/02

(52) U.S. Cl. 492/56; 427/374.1

(57) ABSTRACT

Provided are a method for producing a roller for office automation (OA) equipment, the roller capable of realizing an increase in the printing speed and having a good releasing property, and a roller for OA equipment. The method for producing a roller for OA equipment, the roller including a fluororesin layer provided on an outer circumferential surface of a tubular base either directly or with an intermediate layer therebetween, includes the steps of preparing a fluororesin coating material containing a tetrafluoroethylene-perfluoroalkylvinylether copolymer (PFA) and polytetrafluoroethylene (PTFE) in a ratio of 99:1 to 50:50 (mass ratio); applying the fluororesin coating material onto an outer circumferential surface of a tubular base either directly or with an intermediate layer therebetween; baking the fluororesin coating material at a temperature of 340° C. or higher to form a fluororesin layer; and after baking, cooling the fluororesin layer at a cooling rate of 20° C./min or less.

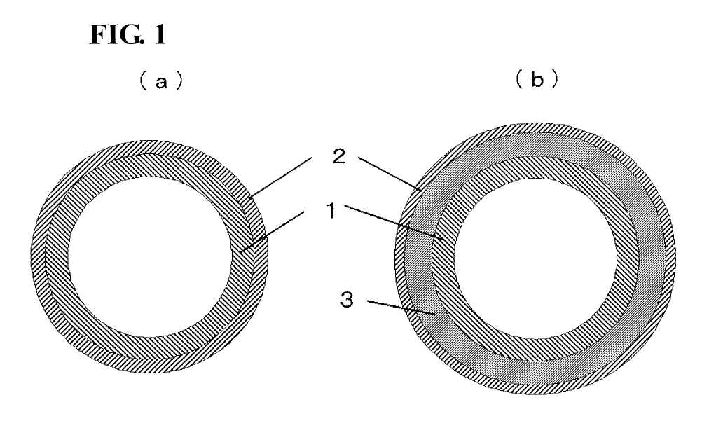

### TECHNICAL FIELD

The present invention relates to a method for producing a roller for office automation (OA) equipment, the roller being used for fixing a toner image transferred to a transfer-receiving material, such as a recording sheet, by heating in OA equipment such as a copy machine or a printer, and a roller for OA equipment.

### BACKGROUND ART

In a final stage of printing or copying in image-forming apparatuses such as a copy machine and a laser beam printer, a heat fixing method is generally employed in which a heating fixing roller having a heating source therein is brought into contact with a pressure roller under pressure, and a transfer-receiving material having a transferred toner image thereon is caused to pass between the heating fixing roller and the pressure roller to melt unfixed toner by heating.

An example of the heating fixing roller that is generally used has a structure obtained by forming a fluororesin layer on an outer circumferential surface (surface to be in contact with a transfer-receiving material) of a cylindrical base composed of polyimide, a metal, or the like either directly or with another layer therebetween. A fixing roller including the other layer composed of rubber or the like that is excellent in terms of elasticity, a releasing property, wear resistance, etc. is also referred to as a “fixing sleeve”. In order to satisfactorily fix a toner, it is necessary to prevent so-called offset in which the toner remains on the fixing roller, resulting in double transfer. Thus, a surface layer of the heating fixing roller requires a property of releasing the toner (i.e., releasing property). Furthermore, the surface layer of the heating fixing roller also requires wear resistance so as to withstand the pressure of the pressure roller.

For example, polytetrafluoroethylene (PTFE), a tetrafluoroethylene-perfluoroalkylvinylether copolymer (PFA), or a tetrafluoroethylene-hexafluoropropylene copolymer (FEP) is used as a fluororesin. The fluororesin layer is usually formed by applying a dispersion liquid (coating material) containing such a fluororesin onto a base either directly or with another layer therebetween, and then baking the resulting film.

Relatively inexpensive PTFE has been generally used as the fluororesin. However, with an improvement in properties, such as a releasing property, required for a fixing roller, a coating material obtained by mixing PFA, which is expensive but has a low molecular weight and exhibits a releasing property better than PTFE, with PTFE has been used. For example, PTL 1 describes a fixing roller including a fluororesin layer formed by using a fluororesin mixture containing 20% to 97% by weight of PFA and 3% to 80% by weight of PTFE. PTL 1 describes that the balance between a releasing property and wear resistance can be achieved by using the mixture of PFA and PTFE. The fluororesin layer is formed by applying a coating material (mixture of fluororesins) onto a surface of a base, drying the resulting film, and then baking the film at 350° C. for 20 minutes (paragraph 0021).

Furthermore, PTL 2 discloses a fixing belt having a releasing layer composed of a specific fluororesin on a surface thereof. PTL 2 describes that the fluororesin layer is preferably formed by applying a fluororesin coating material, heating the resulting film at a temperature higher than the melting point of the fluororesin, and then rapidly cooling the film at a cooling rate of 10° C./min or more (claim 4 and paragraph 0016). It is described that, by rapidly cooling the film, the heat quantity of melting of the releasing layer (fluororesin layer) can be controlled to be a certain value or less and a film that does not tend to crystallize and that is relatively hard can be formed.

### CITATION LIST

### Patent Literature

PTL 1: Japanese Unexamined Patent Application Publication No. 10-142990
PTL 2: Japanese Unexamined Patent Application Publication No. 2003-114585

### SUMMARY OF INVENTION

### Technical Problem

A fluororesin layer is formed by applying a fluororesin coating material, and then baking the coating material. In the related art, as described in PTL 2, a toner-releasing property is improved by conducting rapid cooling so as to prevent crystallization of a fluororesin. The reason for this is as follows: When a fluororesin, in particular, PTFE having a high degree of crystallinity, is slowly cooled and the degree of crystallinity of the resin becomes high, a lamellar structure (fibrous structure) is formed on a surface of a fluororesin layer. Consequently, the surface roughness of the fluororesin layer is increased, thereby decreasing the releasing property.

With an increase in the printing speed of image-forming apparatuses, a further improvement in the releasing property and wear resistance has been desired for a fixing roller, and thus it is necessary to improve the releasing property of a fluororesin layer. The use of a coating material prepared by mixing PTFE and PFA has realized an improvement in the releasing property to a certain degree. However, the properties required have become stricter, and a further improvement in the releasing property has been desired.

An object of the present invention is to provide a method for producing a roller for OA equipment, the roller being capable of realizing an increase in the printing speed and having a good releasing property, and a roller for OA equipment.

### Solution to Problem

An invention according to claim 1 is a method for producing a roller for office automation (OA) equipment, the roller including a fluororesin layer provided on an outer circumferential surface of a tubular base either directly or with an intermediate layer therebetween, the method including the steps of preparing a fluororesin coating material containing a tetrafluoroethylene-perfluoroalkylvinylether copolymer (PFA) and polytetrafluoroethylene (PTFE) in a ratio of 99:1 to 50:50 (mass ratio); applying the fluororesin coating material onto an outer circumferential surface of a tubular base either directly or with an intermediate layer therebetween; baking the fluororesin coating material at a temperature of 340° C. or higher to form a fluororesin layer; and after baking, cooling the fluororesin layer at a cooling rate of 20° C./min or less.

The inventors of the present invention have conducted studies on baking conditions and crystallization of fluororesins, and found that, in the case where a coating material obtained by mixing PFA with PTFE is used as a fluororesin, the behavior of crystallization is different from the case of PTFE. Unlike PTFE, PFA is less crystallized than PTFE, and thus does not tend to form a lamellar structure. It was found that the degree of crystallinity of PFA is increased not by conducting rapid cooling as in the case of the related art but by conducting slow cooling at a cooling rate of 20° C./min or less, and thus the releasing property of the fluororesin layer can be improved. Crystallization of PTFE easily proceeds and surface irregularities due to a lamellar structure tend to be formed. However, the surface irregularities can be suppressed by controlling the mixing ratio of PFA to PTFE to 99:1 to 50:50. In addition, in the case where PFA and PTFE are mixed in the above ratio, PTFE substantially functions as a crystal nucleating agent in the cooling step, and the degree of crystallinity of PFA can be further increased.

It should be noted that a roller having a structure in which a fluororesin layer is provided on a base composed of polyimide, a metal, or the like may be referred to as a “tube roller”, and a roller having a structure in which a rubber elastic layer is provided between a base and a fluororesin layer may be referred to as a “sleeve roller”. In this description, these rollers are generically referred to as “rollers for OA equipment”.

An invention according to claim 2 is the method for producing a roller for OA equipment according to claim 1, wherein the cooling rate after the formation of the fluororesin layer is 15° C./min or less. When the cooling rate is 15° C./min or less, the degree of crystallinity is further increased, and the releasing property of the roller for OA equipment can be improved.

An invention according to claim 3 is the method for producing a roller for OA equipment according to claim 1 or 2, wherein the tubular base is a base composed of a polyimide tube or a base obtained by covering a polyimide tube with an elastic layer. Polyimide is preferable because it is excellent in terms of heat resistance, dimensional stability, chemical properties, and mechanical strength.

An invention according to claim 4 is a roller for OA equipment, the roller including a fluororesin layer provided on an outer circumferential surface of a tubular base either directly or with an intermediate layer therebetween, wherein the fluororesin layer is formed by baking a fluororesin coating material containing a tetrafluoroethylene-perfluoroalkylvinylether copolymer (PFA) and polytetrafluoroethylene (PTFE) in a ratio of 99:1 to 50:50 (mass ratio), and a differential scanning calorimetry (DSC) endothermic quantity of the fluororesin layer is 25 mJ/mg or more. The DSC endothermic quantity correlates with the degree of crystallinity of a fluororesin. The larger the endothermic quantity, the higher the degree of crystallinity, and the more the releasing property is improved. Note that the DSC endothermic quantity is a value measured in accordance with JIS K7121. Although the DSC endothermic quantity depends on the mixing ratio of PFA to PTFE (with an increase in the proportion of PTFE mixed, the DSC endothermic quantity increases), it is believed that as long as the mixing ratio of PFA to PTFE is within the range of 99:1 to 50:50 (mass ratio), when the DSC endothermic quantity is 25 mJ/mg or more, the fluororesin has a degree of crystallinity sufficient for obtaining a satisfactory releasing property.

### Advantageous Effects of Invention

According to the present invention, it is possible to produce a roller for OA equipment, which has a surface with a good releasing property, and with which offset does not tend to occur even when the printing speed is increased.

### BRIEF DESCRIPTION OF DRAWING

FIGURE is a schematic cross-sectional view illustrating an example of a roller for OA equipment of the present invention.

### DESCRIPTION OF EMBODIMENTS

FIGURE is a schematic cross-sectional view illustrating an example of a roller for OA equipment. In part (a) of FIGURE, a fluororesin layer 2 is formed on the outer circumferential surface of a tubular base 1. In part (b) of FIGURE, an elastic layer 3 covers the outside of a tubular base 1, and a fluororesin layer 2 is formed on the outer circumferential surface of the elastic layer 3. A roller having the structure illustrated in part (a) of FIGURE is referred to as a tube roller, and a roller having the structure illustrated in part (b) of FIGURE is referred to as a sleeve roller. A primer layer may be provided between the fluororesin layer 2 and the tubular base 1 or between the fluororesin layer 2 and the elastic layer 3. The adhesion between the fluororesin layer 2 and the layer disposed thereunder can be improved by providing the primer layer.

The thickness of the base 1 is not particularly limited, but is preferably 30 to 80 μm from the standpoint of durability and elasticity. For example, a heat-resistant resin such as polyamide or polyimide or a metal is used as the material of the base 1. Considering the strength, heat resistance, and formability, polyimide is preferably used. An example of a method for producing the base 1 includes applying a solution (polyimide varnish) of a polyimide precursor (polyamic acid) onto the outer circumferential surface of a cylindrical metal core, and then dehydrating and cyclizing the precursor by heating to obtain a polyimide tube. The heating temperature of the polyimide is 350° C. to 450° C.

The polyimide precursor is used in the form of a solution prepared by dissolving the polyimide precursor in a solvent such as N-methylpyrrolidone or dimethylacetamide. For example, U-Varnish-S produced by Ube Industries, Ltd. can be used as the polyimide precursor solution (polyimide varnish). In order to improve the characteristics of the base, an additive such as a thermally conductive filler may be mixed in the polyimide varnish.

By providing the elastic layer 3 on the outside of the base 1, the elasticity of the roller is increased to improve fixability of a toner. Heat-resistant rubber such as silicone rubber or fluororubber can be used as the material of the elastic layer 3. An additive such as a thermally conductive filler may be mixed in the heat-resistant rubber. The thickness of the elastic layer 3 is preferably 20 to 100 μm. The elastic layer can be formed by applying a material of heat-resistant rubber on the outer circumferential surface of the base, and then conducting hot vulcanization.

The fluororesin layer is formed by using a fluororesin coating material containing a tetrafluoroethylene-perfluoroalkylvinylether copolymer (PFA) and polytetrafluoroethylene (PTFE) in a ratio of 99:1 to 50:50 (mass ratio). Each of the PFA and PTFE can be used in the form of a dispersion liquid in which the PFA or PTFE is dispersed in water. The dispersion liquids are mixed so that the mass ratio of the PFA to PTFE is within the above range, and used.

In addition to the fluororesin, an inorganic filler such as tin oxide, titanium oxide, or alumina or an electrically conductive filler such as carbon black or carbon nanotubes may be added to the fluororesin coating material.

The fluororesin layer is formed as follows. First, the fluororesin coating material is applied onto the outer circumferential surface of the base. The coating thickness is not particularly limited, but is determined so that the thickness of the fluororesin layer after baking is preferably 1 to 50 μm, and more preferably 2 to 35 μm.

The base on which the fluororesin coating material has been applied is placed in a heating furnace. The temperature is increased to evaporate the solvent in the coating material and to bake the fluororesin coating material. Preferably, the baking temperature is 300° C. or higher, and the heating is conducted for five minutes or more. After baking, cooling is conducted so that the temperature of the surface of the base (fluororesin layer) is decreased at a rate of 20° C./min or less by controlling the temperature of the heating furnace. The cooling is preferably conducted at a rate of 20° C./min or less until the temperature becomes 200° C. or lower, and more preferably 150° C. or lower.

The formation of the primer layer between the base and the fluororesin layer or between the elastic layer and the fluororesin layer is preferable because the adhesion between the base and the fluororesin layer is improved. The material of the primer layer is not particularly limited. For example, a rubber-based primer material or a fluorine-based primer material can be used. An inorganic filler or an electrically conductive filler may be added to the primer layer.

### EXAMPLES

Next, the present invention will be described in more detail on the basis of Examples. However, the Examples do not limit the scope of the present invention.

(Preparation of Base)

An organic solvent solution of a polyimide precursor (produced by Ube Industries, Ltd., trade name: U-Varnish-S) containing an appropriate amount of filler for improving thermal conductivity was applied onto the outer circumferential surface of a cylindrical metal core by a dispenser method. The cylindrical core was then heated to about 350° C. to 450° C. Thus, the precursor was dehydrated and cyclized to obtain polyimide. The resulting polyimide film was detached from the cylindrical core to prepare a tubular base. The dimensions of this base were 50 μm in thickness, 26 mm in inner diameter, and 24 cm in length.

(Fluororesin Coating Material)

A fluororesin coating material was prepared by mixing a filler (inorganic filler) with an aqueous dispersion liquid of PFA (produced by Du Pont-Mitsui Fluorochemicals Co., Ltd.) and an aqueous dispersion liquid of PTFE (produced by Du Pont-Mitsui Fluorochemicals Co., Ltd.) so that 15 parts by weight of the filler was contained relative to 100 parts by weight of the total of the PFA and PTFE resins. The fluororesin coating material was applied onto the base, and the base was then placed in a heating furnace. The temperature was increased to 400° C., and baking was then conducted at 400° C. for 30 minutes. After the baking, cooling was conducted to 150° C. at a cooling rate shown in Table, thus forming a fluororesin layer. The fluororesin layer had a thickness of 12 μm.

(Measurement of DSC Endothermic Quantity)

Only the fluororesin layer was separated from the base, and the DSC endothermic quantity of the fluororesin layer was measured in accordance with JIS K7121 using a differential scanning calorimeter DSC 5200 (produced by Seiko Instruments Inc.).

(Measurement of Contact Angle)

For the prepared tube roller, a contact angle was measured by a tangent line method using a contact angle meter produced by Kyowa Interface Science Co., Ltd. A larger contact angle provides a better releasing property.

(Evaluation of Image Quality)

A black-and-white image was actually printed using the prepared tube roller, and evaluated. A surface temperature during printing was 150° C. and a pressing force was set to 6 kg. Regarding sheet-supplying conditions during printing, 10 A4 printing sheets were successively printed at a rate of 25 sheets/min. The occurrence of color unevenness and the formation of a rough surface were examined by visual observation. The results were evaluated on the basis of the following criteria:

∪: No color unevenness and no rough surface were observed.
◯: Color unevenness and a rough surface were hardly observed.
Δ: Color unevenness and a rough surface were observed, but they were within acceptable ranges.
x: Both color unevenness and a rough surface were out of acceptable ranges.

TABLE

| | | | | | | | | Comparative | Comparative |
|---|---|---|---|---|---|---|---|---|---|
| | | | Example 1 | Example 2 | Example 3 | Example 4 | Example 5 | example 1 | example 2 |
| Coating | Fluororesin | PFA | 70 | 99 | 90 | 80 | 70 | 40 | 20 |
| material | composition | PTFE | 30 | 1 | 10 | 20 | 30 | 60 | 80 |
| composition | (Mixing ratio) | | | | | | | | |
| | Inorganic filler | Type | Titanium oxide | Tin oxide | Tin oxide | Tin oxide | Tin oxide | Tin oxide | Tin oxide |
| Cooling | >20° C./min | Contact angle (°) | 128 | 120 | 120 | 121 | 123 | 130 | 131 |
| rate | | DSC endothermic | 22 | 20 | 20 | 21 | 22 | 25 | 25 |
| | | quantity (mJ/mg) | | | | | | | |
| | | Image quality | X | X | X | X | X | X | X |
| | 20° C./min | Contact angle (°) | 132 | 122 | 123 | 128 | 132 | 133 | 133 |
| | | DSC endothermic | 28 | 24 | 24 | 24 | 28 | 30 | 32 |
| | | quantity (mJ/mg) | | | | | | | |
| | | Image quality | Δ | Δ | Δ | Δ | Δ | X | X |
| | 15° C./min | Contact angle (°) | 133 | 122 | 123 | 127 | 134 | 135 | >135 |
| | | DSC endothermic | 30 | 26 | 26 | 26 | 130 | 32 | 32 |
| | | quantity (mJ/mg) | | | | | | | |
| | | Image quality | ◯ | ◯ | ⊚ | ◯ | ◯ | X | X |
| | 10° C./min | Contact angle (°) | 135 | 125 | 124 | 128 | 134 | >135 | >135 |
| | | DSC endothermic | 29 | 30 | 29 | 29 | 30 | 33 | 34 |
| | | quantity (mJ/mg) | | | | | | | |
| | | Fixability | ⊚ | ⊚ | ⊚ | ⊚ | ⊚ | X | X |
| | 5° C./min | Contact angle (°) | 135 | 125 | 125 | 130 | 135 | >135 | >135 |
| | | DSC endothermic | 31 | 30 | 30 | 30 | 31 | 34 | 34 |
| | | quantity (mJ/mg) | | | | | | | |
| | | Fixability | ⊚ | ⊚ | ⊚ | ⊚ | ⊚ | X | X |
| | <5° C./min | Contact angle (°) | 135 | 125 | 127 | 130 | 135 | >135 | >135 |
| | | DSC endothermic | 33 | 31 | 31 | 32 | 32 | 34 | 35 |
| | | quantity (mJ/mg) | | | | | | | |
| | | Fixability | ⊚ | ⊚ | ⊚ | ⊚ | ⊚ | X | X |

In each of Examples 1 to 5, a fluororesin coating material containing PFA and PTFE in a ratio of 99:1 to 50:50 was used. When the cooling rate was higher than 20° C./min, the DSC endothermic quantity was smaller than 25 mJ/mg and the degree of crystallinity was low. In addition, the evaluation results of the image quality were also not good. In contrast, when the cooling rate was lower than 20° C./min, the DSC endothermic quantity was larger than 25 mJ/mg and the evaluation results of the image quality were also good. Furthermore, it was found that, with a decrease in the cooling rate, the contact angle was increased to improve the releasing property.

In each of Comparative Examples 1 and 2, a fluororesin coating material containing PTFE in an amount larger than the amount of PFA was used. Although the contact angle was large and a good releasing property could be obtained, the image quality was not good. It is believed that this is because irregularities due to crystallization of PTFE were formed on the surface.

### REFERENCE SIGNS LIST

1 base
2 fluororesin layer
3 elastic layer

1. A method for producing a roller for office automation (OA) equipment, the roller including a fluororesin layer provided on an outer circumferential surface of a tubular base either directly or with an intermediate layer therebetween, the method comprising the steps of:
preparing a fluororesin coating material containing a tetrafluoroethylene-perfluoroalkylvinylether copolymer (PFA) and polytetrafluoroethylene (PTFE) in a ratio of 99:1 to 50:50 (mass ratio);
applying the fluororesin coating material onto an outer circumferential surface of a tubular base either directly or with an intermediate layer therebetween;
baking the fluororesin coating material at a temperature of 340° C. or higher to form a fluororesin layer; and
after baking, cooling the fluororesin layer at a cooling rate of 20° C./min or less.

2. The method for producing a roller for OA equipment according to claim 1, wherein the cooling rate after the formation of the fluororesin layer is 15° C./min or less.

3. The method for producing a roller for OA equipment according to claim 1, wherein the tubular base is a base composed of a polyimide tube or a base obtained by covering a polyimide tube with an elastic layer.

4. A roller for OA equipment, the roller comprising a fluororesin layer provided on an outer circumferential surface of a tubular base either directly or with an intermediate layer therebetween,
wherein the fluororesin layer is formed by baking a fluororesin coating material containing a tetrafluoroethylene-perfluoroalkylvinylether copolymer (PFA) and polytetrafluoroethylene (PTFE) in a ratio of 99:1 to 50:50 (mass ratio), and
a differential scanning calorimetry (DSC) endothermic quantity of the fluororesin layer is 25 mJ/mg or more.
